(19) United States
(12) Patent Application Publication
(10) Pub. No.: US 2026/0359427 A1
(43) Pub. Date: Nov. 12, 2026

(54) DETECTION OF ANOMALOUS REPORTS

(71) Applicant: Oracle International Corporation, Redwood Shores, CA (US)

(72) Inventors: Vikas Agrawal, Hyderabad (IN); Akash Baviskar, Maharashtra (IN); Krishnan Ramanathan, Karnataka (IN); Jagdish Chand, Pleasanton, CA (US)

(73) Assignee: Oracle International Corporation, Redwood Shores, CA (US)

(21) Appl. No.: 19/205,667

(22) Filed: May 12, 2025

(51) Int. Cl. G06F 21/55; G06F 40/20

(52) U.S. Cl. CPC G06F 21/552; G06F 40/20

(57) ABSTRACT

Techniques for detecting anomalous reports are disclosed. A plurality of reports corresponding to a plurality of report identifiers are received. Using a language model, a first subset of the plurality of report identifiers are identified as satisfying a first suspiciousness criterion. A factor is determined, based at least in part on the first subset of the plurality of report identifiers. A parameter of an anomaly detection algorithm is set, based at least in part on the factor, the anomaly detection algorithm being different from the language model. Using the anomaly detection algorithm, a second subset of the plurality of report identifiers are identified as satisfying a second suspiciousness criterion. For at least one report identifier within the second subset of the report identifiers, the report corresponding to the at least one report identifier is flagged as being potentially anomalous.

### BACKGROUND

Anomaly detection algorithms aim to detect anomalous entries within a dataset. For example, a user configures parameters of an anomaly detection algorithm, and the configured anomaly detection algorithm detects the anomalous entries. Configuring such anomaly detection algorithms for reliable and accurate performance is a non-trivial task.

### BRIEF SUMMARY

In various embodiments, a non-transitory computer-readable medium includes instructions that when executed by one or more processors, cause the one or more processors to perform operations including: receiving a plurality of reports corresponding to a plurality of report identifiers; identifying, using a language model, a first subset of the plurality of report identifiers as satisfying a first suspiciousness criterion; determining a factor that is based at least in part on the first subset of the plurality of report identifiers; setting a parameter of an anomaly detection algorithm, based at least in part on the factor, the anomaly detection algorithm being different from the language model; identifying, using the anomaly detection algorithm, a second subset of the plurality of report identifiers as satisfying a second suspiciousness criterion; and flagging, for at least one report identifier within the second subset of the report identifiers, the report corresponding to the at least one report identifier as being potentially anomalous. In an example, flagging the report comprises: identifying that the at least one report identifier is within the first subset of the report identifiers and within the second subset of the report identifiers; and in response to identifying that the at least one report identifier is within the first subset of the report identifiers and within the second subset of the report identifiers, flagging, for the at least one report identifier, the report corresponding to the at least one report identifier as being potentially anomalous. In an example, the at least one report identifier is a first report identifier, the report corresponding to the at least one report identifier is a first report, and wherein flagging the first report comprises: flagging the first report as being potentially anomalous with a first confidence level, wherein the operations further include flagging, for a second report identifier that is within the second subset of the report identifiers and not within the first subset of the report identifiers, a second report corresponding to the second report identifier as being potentially anomalous with a second confidence level, and wherein the first confidence level is higher than the second confidence level. In an example, the operations further include: flagging, for a third report identifier that is within the first subset of the report identifiers and not within the second subset of the report identifiers, a third report corresponding to the third report identifier as being potentially anomalous with a third confidence level, wherein the first confidence level is higher than the third confidence level. In an example, the second confidence level and the third confidence level are the same.

In an example, the operations further include: subsequent to identifying the second subset of the plurality of report identifiers, determining a ratio of (i) a number of unique report identifiers that are within both the first subset and the second subset, and (ii) a number of unique report identifiers that are within at least one of the first subset and the second subset; determining that the ratio is less than a threshold; in response to determining that the ratio is less than the threshold, tuning one or more parameters of the anomaly detection algorithm; and updating, using the anomaly detection algorithm with the tuned one or more parameters, the second subset of the plurality of report identifiers as satisfying the second suspiciousness criterion, wherein the at least one report identifier is within the second subset of the report identifiers subsequent to the updating of the second subset. In an example, the threshold is at least 0.5. In an example, the anomaly detection algorithm is an isolation forest, and wherein the one or more parameters that are tuned comprise one or more of: a contamination parameter that specifies a proportion of a dataset is expected to be identified by the isolation forest as being anomalous; a number of individual isolation trees within the isolation forest; a subsampling size that specifies a number of samples to draw from a training data for each isolation tree; a number of features to consider for splitting at each node in the isolation trees; and an outlier score threshold that defines a threshold above which data points are flagged as outliers.

In an example, the anomaly detection algorithm is an isolation forest, and wherein setting the parameter of the anomaly detection algorithm comprises: setting a contamination parameter of the isolation forest as a function of the factor. In an example, the anomaly detection algorithm is an isolation forest, and wherein setting the parameter of the anomaly detection algorithm comprises: setting a contamination parameter of the isolation forest to be equal to the factor. In an example, the factor is based at least in part on a ratio of (i) a number of report identifiers within the first subset of the plurality of report identifiers and (ii) a number of report identifiers within the plurality of report identifiers.

In an example, the operations further include: prior to identifying the first subset and the second subset, processing the plurality of reports, wherein processing the plurality of reports comprises translating a description of a report from a first language to a second language. In an example, the operations further include: prior to identifying the first subset and the second subset, processing the plurality of reports, wherein processing the plurality of reports comprises determining, using a small language model and from a description of a report, a number of personnel and/or a number of days associated with an event for the report. In an example, the operations further include: prior to identifying the first subset and the second subset, processing the plurality of reports, wherein processing the plurality of reports comprises determining, from a description of a report, a type of an event for the report. In an example, the language model is a pretrained small language model (SLM). In an example, the anomaly detection algorithm is an isolation forest.

In various embodiments, a method comprises: receiving a plurality of reports corresponding to a plurality of report identifiers; identifying, using a language model, a first subset of the plurality of report identifiers as satisfying a first suspiciousness criterion; determining a factor that is based at least in part on the first subset of the plurality of report identifiers; setting a parameter of an anomaly detection algorithm, based at least in part on the factor, the anomaly detection algorithm being different from the language model; identifying, using the anomaly detection algorithm, a second subset of the plurality of report identifiers as satisfying a second suspiciousness criterion; and flagging, for at least one report identifier within the second subset of the report identifiers, the report corresponding to the at least one report identifier as being potentially anomalous. In an example, the factor is based at least in part on a ratio of (i) a number of report identifiers within the first subset of the plurality of report identifiers and (ii) a number of report identifiers within the plurality of report identifiers; the anomaly detection algorithm is an isolation forest; and the parameter is a contamination parameter of the isolation forest.

In various embodiments, a system comprises: one or more processors; and one or more non-transitory computer-readable media storing instructions, which, when executed by the system, cause the system to perform a set of actions including: receiving a plurality of reports corresponding to a plurality of report identifiers; identifying, using a language model, a first subset of the plurality of report identifiers as satisfying a first suspiciousness criterion; determining a factor that is based at least in part on the first subset of the plurality of report identifiers; setting a parameter of an anomaly detection algorithm, based at least in part on the factor, the anomaly detection algorithm being different from the language model; identifying, using the anomaly detection algorithm, a second subset of the plurality of report identifiers as satisfying a second suspiciousness criterion; and flagging, for at least one report identifier within the second subset of the report identifiers, the report corresponding to the at least one report identifier as being potentially anomalous. In an example, the factor is based at least in part on a ratio of (i) a number of report identifiers within the first subset of the plurality of report identifiers and (ii) a number of report identifiers within the plurality of report identifiers; the anomaly detection algorithm is an isolation forest; and the parameter is a contamination parameter of the isolation forest.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions, such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates an anomaly detection system to detect potentially anomalous reports.

FIG. 2A illustrates a table including example plurality of reports having corresponding plurality of report identifiers.

FIG. 2B illustrates a table including a plurality of processed reports associated with a corresponding plurality of report identifiers.

FIG. 3A illustrates a flowchart depicting a method for processing a plurality of reports, prior to the reports being analyzed for anomaly detection.

FIG. 3B illustrates a process flow for processing a report, to generate a corresponding processed report.

FIG. 4A illustrates a flowchart depicting a method for detecting anomalous reports.

FIG. 4B illustrates a process flow 450 for detecting anomalous reports.

FIG. 5 illustrates a flowchart depicting a method for fine tuning an anomaly detection algorithm, based on (i) a first subset of report identifiers that satisfies a first suspiciousness criterion of a language model and (ii) a second subset of report identifiers that satisfies a second suspiciousness criterion of the anomaly detection algorithm.

FIG. 6 depicts a simplified diagram of a distributed system for implementing certain aspects.

FIG. 7 is a simplified block diagram of one or more components of a system environment by which services provided by one or more components of an embodiment system may be offered as cloud services, in accordance with certain aspects.

FIG. 8 illustrates an example computer system that may be used to implement certain aspects.

### DETAILED DESCRIPTION

A personnel associated with an organization may submit one or more reports to the organization. If the organization finds the report to be valid, the organization acts on the report. A large organization may receive a large number of such reports. Reviewing the reports for anomalies is a time and resource consuming task. Although automated tools may be used to validate the reports, such approaches require customers to specify thresholds or expected prevalence of anomalies within the dataset, and/or otherwise configure parameters of such automated tools. However, because thresholds or expected prevalence of anomalies within the dataset may be unknown a-priori and/or as the parameters are configured without taking into account nuances of the dataset to be analyzed, such approaches may result in a relatively large number of false positives or false negatives while detecting anomalies in the dataset.

Accordingly, techniques are disclosed herein for detection of anomalous reports, where the techniques further include estimating expected prevalence of anomalies within the reports. Intelligently estimating the expected prevalence of anomalies within the reports (e.g., instead of randomly providing an expected prevalence of anomalies) results in reduced false positives or false negatives in anomaly detection. Furthermore, the techniques may also be used to extract various attributes of the reports from corresponding descriptions, which further facilitate in anomaly detection of the reports.

The below described anomaly detection techniques can be applied to various types of reports, such as expense reports, job order reports, clinical reports, and/or a plethora of other types of reports generated and/or processed within an organization. In this disclosure, expense reports are used as examples of reports on which the anomaly detection techniques can be applied. However, the teachings of this disclosure are not limited to expense reports, and can be applied to other types of reports as well.

For example, and as will be described below in further detail, an organization may receive a plurality of reports. Each report has a corresponding report identifier, such that the plurality of reports is associated with a corresponding plurality of report identifiers.

A report processing service may initially process the reports. For example, each report may be accompanied by a corresponding description. In an example, the report processing service translates description of one or more reports to a common language (such as English or another common language), e.g., using a first language model (which may be a trained small language model (SLM) or a large language model (LLM)).

In an example, the reports may not be pre-populated with an associated number of participants. For example, if a party of six people attends a dinner and the cost of the dinner is submitted for reimbursement within an expense report, an expense description of the associated expense report may include names of the six people who attended the dinner, but a “number of people” field or attribute may be left blank by a submitter of the report. In an example, the report processing service may use the first language model, which may parse the description and determine a number of participants associated with event of the report.

In an example, some reports may not be pre-populated with an associated number of days over which an associated event occurred (such as six days of hotel stay) and/or a type of the associated event (such as hotel stay or accommodation). In an example, the report processing service may use the first language model, which may parse the description, and determine a number of days and/or type of the event associated with the report. Similarly, one or more other attributes of the report may also be determined from the description, such as (e.g., assuming that the report is an expense report) (i) a location in which an event associated with the report occurred, (ii) a position of the person incurring an expense associated with the report (e.g., a high-level employee, such as an executive of an organization may have a higher budget for accommodation and travel compared to that of a low-level employee), (iii) a budget that was pre-authorized for the event, (iv) company policies associated with related events, (v) a currency code (e.g., USD, Canadian dollar (CAD), Euro (EUR), etc.) in which the expense incurred, and/or (vi) other relevant information that may facilitate in detecting anomalous reports.

After the reports are processed by the report processing service, an anomaly detection system aims to detect anomalies within the reports (such as flags one or more reports as possibly being anomalous). Examples of anomalous reports have been described below in further detail.

In an example, the anomaly detection system comprises a second language model, which may be a trained SLM or an LLM. Note that the second language model may be same as, or different from, the above-described first language model used to initially process the reports.

The second language model is trained to detect anomalies within a plurality of reports. For example, the second language model reviews each of the processed reports. If the second language model estimates a processed report to be possibly anomalous (e.g., satisfying a suspiciousness criterion of the second language model), the second language model adds the corresponding report identifier of the anomalous report to a first subset of the plurality of report identifiers. Thus, the first subset of the plurality of report identifiers includes those identifiers, which have corresponding reports that are viewed as being suspicious by the second language model (e.g., satisfying a suspiciousness criterion of the second language model).

Subsequently, a prevalence factor P(A) is determined. As an example, the prevalence factor P(A) is calculated as sum(Ai)/N, where N is a total number of report identifiers for the plurality of reports, and sum(Ai) is a total number of report identifiers within the first subset of the plurality of reports. Thus, the prevalence factor P(A) is indicative of prevalence of anomalies within the plurality of reports being considered, as detected by the second language model. Hence, in an example, the prevalence factor P(A) is also indicative of “expected” prevalence of anomalies within the plurality of reports being considered.

The anomaly detection system also includes an anomaly detection algorithm that is different from the second language model. In an example, the anomaly detection algorithm is an isolation forest, although another anomaly detection algorithm may also be used. Isolation forest is an unsupervised machine learning algorithm used for anomaly detection. For example, isolation forest identifies outliers within a dataset.

Isolation forest has a configurable contamination parameter, which specifies a proportion of the dataset that is expected to be anomalies or outliers. Merely as an example, if the contamination parameter in isolation forest is set to 3%, the isolation forest aims to find about 3% of the processed reports as being anomalous. Thus, the contamination parameter represents an expected fraction of anomalies in the dataset.

In an example, the above-described prevalence factor P(A) is used to set the contamination parameter of the isolation forest. For example, the contamination parameter of the isolation forest is set to be same as (or at least within a given range of) the prevalence factor P(A).

Thus, instead of randomly selecting the contamination parameter of the isolation forest, the contamination parameter of the isolation forest is selected based on the prevalence factor P(A) that is derived based on anomalous reports identified by the second language model. Such intelligent selection of the contamination parameter of the isolation forest results in improvement of anomaly detection by the isolation forest. Thus, the isolation forest aims to identify anomalies at approximately the same rate at which the second language model detected anomalies in the plurality of reports.

Now, the isolation forest (whose contamination parameter has been configured as described above) also identifies anomalous reports from the plurality of reports, and adds the corresponding report identifiers to a second subset of the plurality of report identifiers. Thus, the isolation forest reviews each of processed reports. If the isolation forest estimates a processed report to be possibly anomalous (e.g., satisfying a suspiciousness criterion of the isolation forest), the isolation forest adds the corresponding report identifier to the identified second subset.

Because the contamination parameter of the isolation forest is set in accordance with the prevalence factor P(A), a number of report identifiers within the second subset identified by the isolation forest may be in the same range (e.g., within 20%, or 10%, or 5%, or 3%, or 2%, or 1% of each other) as a number of report identifiers within the second subset identified by the second language model. However, although the number of anomalies detected by the second language model and the isolation forest may be in the same range, there may be some non-overlap on the actual reports flagged as being anomalous by the second language model and the isolation forest. That is, in an example, there may be some disagreement between the anomalous reports detected by the second language model and the isolation forest.

Accordingly, in an example, one or more parameters of the isolation forest may be further tuned, to maximize the overlap between anomalous reports flagged by the second language model and the isolation forest. The tuning process may want to maximize or at least increase an agreement ratio (e.g., aim to make the agreement ratio higher than a threshold), which may be defined as a ratio of (i) a number of (report identifiers within the first subset n report identifiers within second subset) and (ii) a number of (report identifiers within first subset U report identifiers within second subset). Here, N and U are union and intersection operators, respectively, and have been described below in further detail. Various examples of parameter tuning, to increase the agreement ratio, have also been described below in further detail. By tuning the parameters of the isolation forest, the anomaly detection system iteratively aims to increase overlap between anomalous reports detected by the second language model and the isolation forest.

Once the parameters of the isolation forest have been tuned and the isolation forest have updated the anomalous reports and the corresponding report identifiers within the second subset of the plurality of report identifiers, the anomaly detection system outputs final classification of anomalous reports.

In an example, reports classified as being anomalous by both the second language model and the isolation forest are assigned a final anomalous flag. In an example, reports classified as being anomalous by only one (but not both) of the second language model and the isolation forest may also be assigned a final anomalous flag, but with a relatively lower confidence level.

A technical challenge addressed by some embodiments of the invention relates to tuning parameters of an anomaly detection algorithm (such as isolation forest), based on anomaly detection performed by a language model. Traditional systems may use an anomaly detection algorithm to detect anomalous reports within a particular dataset. However, such detection is prone to high level of false positives or false negatives, as parameters of the anomaly detection algorithm are preset randomly or using historic data, and are not adjusted to take into account nuances of the particular dataset being considered.

A technical solution provided by some embodiments includes techniques that leverage prevalence of anomaly detected by a language model on a given dataset, and use the detected prevalence to tune parameters of an anomaly detection algorithm, where the tuned anomaly detection algorithm is then applied to detect anomalous entries within the given dataset. Detecting anomalies within the given dataset using both the language model and the anomaly detection algorithm improves reliability of anomaly detection, and reduces false positives and false negatives of detected anomalies. Importantly, intelligently tuning parameters of the anomaly detection algorithm (e.g., in real or near-real time), based on prevalence of anomalies detected by the language model on the given dataset, also improves detection capabilities of the anomaly detection algorithm on the given dataset, and further improves false positives and false negatives of detected anomalies.

Numerous examples and configurations of the anomaly detection system have been described below in further detail.

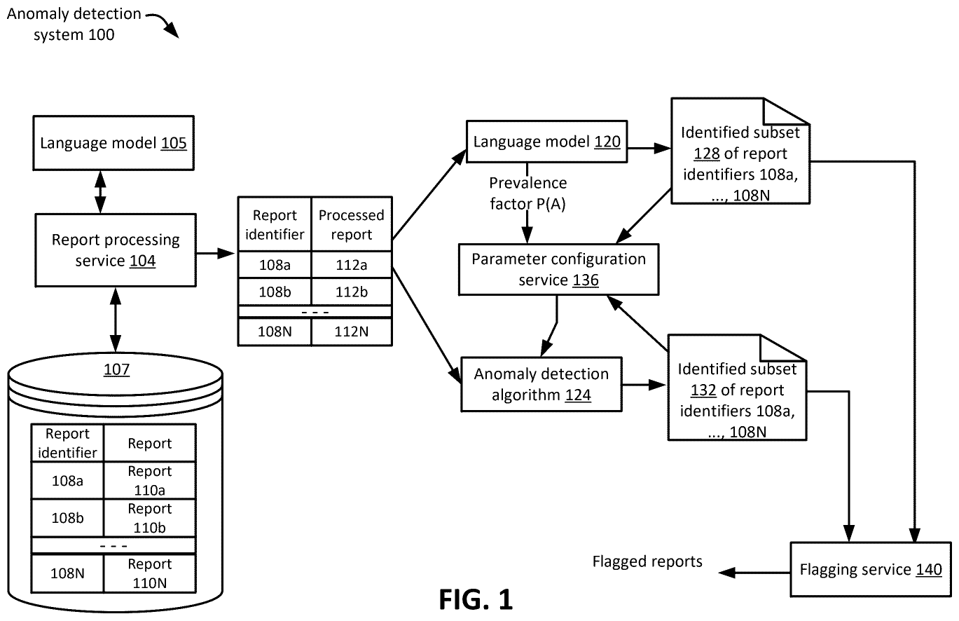

FIG. 1 illustrates an anomaly detection system 100 to detect potentially anomalous reports. The anomaly detection system 100 includes (or has access to) a storage repository 107 that stores a plurality of reports 110a, 110b, 110c, . . . , 110N, and corresponding report identifiers 108a, 108b, 108c, . . . , 108N. For example, report 110a has a report identifier 108a, report 110b has a report identifier 108b, and so on.

The reports 110a, . . . , 110N can be any type of reports, such as expense reports, job order reports, clinical reports, and/or a plethora of other types of reports generated and/or processed within an organization. In this disclosure, expense reports are used as examples of reports on which the anomaly detection techniques can be applied. However, the teachings of this disclosure are not limited to expense reports, and can be applied to other types of reports as well.

In an example, the reports 110a, . . . , 110N may be for one or more employees, contractors, clients, and/or volunteers of an organization, which have been submitted for reimbursement. In an example, the reports 110a, . . . , 110N may be for an organization that spans across multiple regions or countries, such that descriptions associated with the reports 110a, . . . , 110N may be in more than one language (e.g., a first description for a first report may be in English, and a second description for a second report may be in Germany).

Other use cases may also be possible. For example, the reports 110a, . . . , 110N may be submitted to a report processing company that processes reports of employees of multiple organizations, and the reports 110a, . . . , 110N may include information (such as expenses) submitted by a plurality of employees from a plurality of organizations.

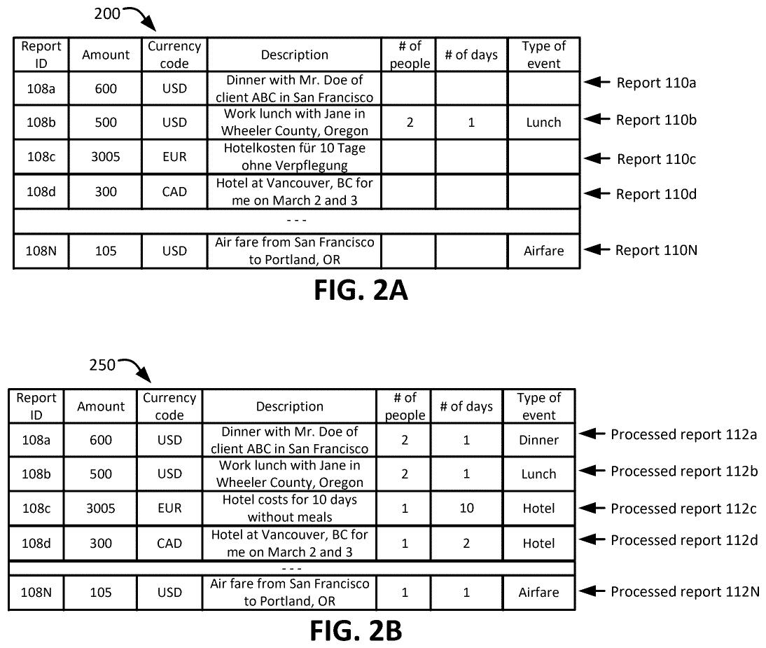

FIG. 2A illustrates a table 200 including example plurality of reports 110a, . . . , 110N having corresponding plurality of report identifiers (IDs) 108a, . . . , 108N. The reports 110a, . . . , 110N of FIG. 2A are assumed to be expense reports. The table 200 has various attributes associated with each of the reports 110a, . . . , 110N, such as an amount requested for reimbursement, a currency code in which the corresponding expense incurred, a description (such as an expense description), a number of participants associated with the corresponding event, a number of days over which the event occurred, a type of event for which the expense was incurred, etc.

In an example and as illustrated in FIG. 2A, not all attributes of a report may be completed by a person submitting the report. For example, for the report 110a corresponding to the report identifier 108a, the report mentions an expense amount of 600 USD (United States dollars), with an item description of “Dinner with Mr. Doe of client ABC in San Francisco.” However, the report 110a is silent on the number of participants associated with the report 110a, or over how many days the dinner took place (which may usually be one), and does not even specify a type of the underlying event (which may be meal or dinner). Thus, a submitter of the report intentionally or inadvertently did not complete all attributes of the report 110a. Other example reports 110b, 110c, . . . , 110N of FIG. 2A will be self-evident from the figure.

Referring again to FIG. 1, in an example, the anomaly detection system 100 aims to detect anomalies within the reports 110a, . . . , 110N. For example, referring to the report 110a of FIG. 2A, $600 for “Dinner with Mr. Doe of client ABC in San Francisco” may seem to be too expensive (e.g., $300 per person dinner). However, the location of the dinner is at San Francisco, which is known for its high cost of living and expensive restaurants for dinner. Additionally, or alternatively, this dinner is with a client, and hence, the organization may splurge on the dinner. Accordingly, this report 110a may not be suspicious or anomalous, albeit having a relatively high cost per person for dinner. In contrast, the report 110b is for “Work lunch with Jane in Wheeler County, Oregon.” Wheeler County is a small rural county in Oregon and has a relatively low cost of living (e.g., compared to San Francisco). Accordingly, $500 for the expense captured in the report 110b may be too excessive and may possibly be anomalous. In an example, the anomaly detection system 100 aims to detect any anomalous or suspicious reports within the plurality of reports 110a, . . . , 110N stored in the storage repository 107.

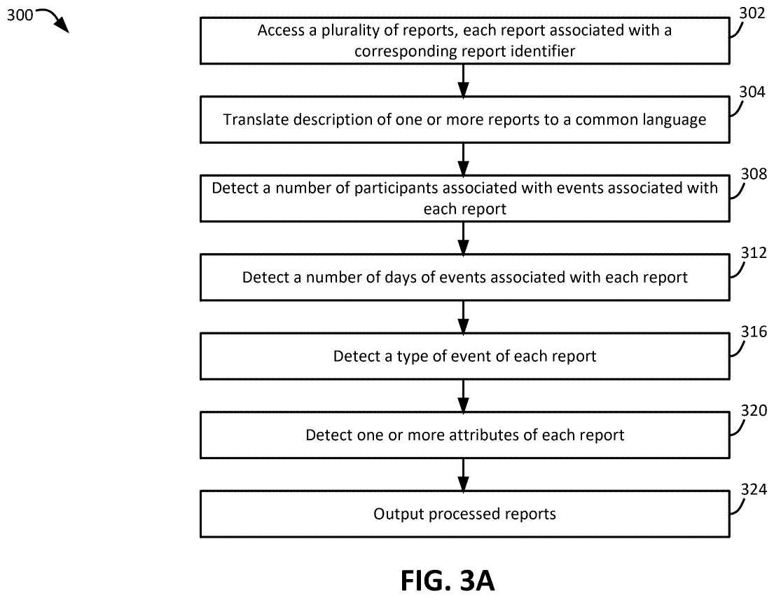

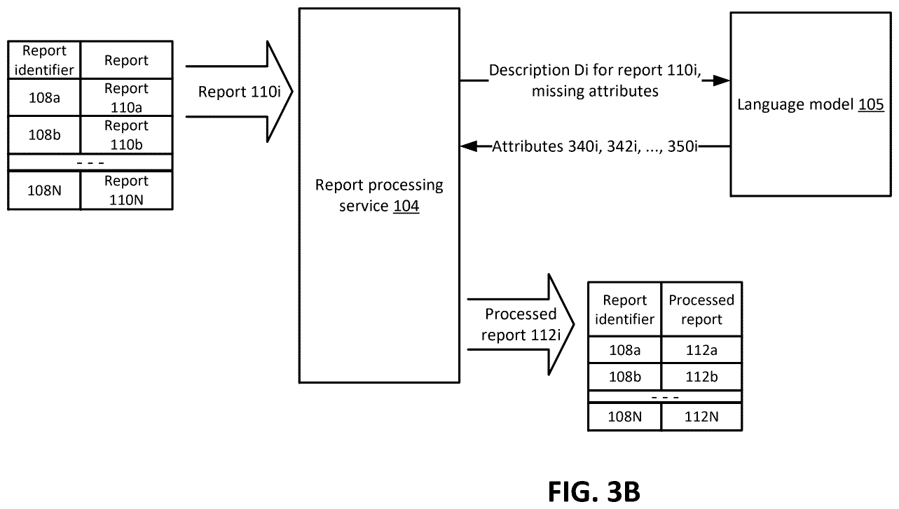

The anomaly detection system 100 comprises a report processing service 104, which processes the reports 110a, . . . , 110N, prior to the reports 110a, . . . , 110N being analyzed for anomaly detection. FIG. 3A illustrates a flowchart depicting a method 300 for processing (e.g., by the report processing service 104) a plurality of reports 110a, . . . , 110N, prior to the reports 110a, . . . , 110N being analyzed for anomaly detection. While various blocks are shown in a particular order, the order may be modified. For example, some blocks may be performed before others, while some blocks may be performed simultaneously. In an example, execution of some of the blocks may be optional.

At 302 of the method 300, the report processing service 104 accesses a plurality of reports, where each report is associated with a corresponding report identifier. For example, reports 110a, . . . , 110N and associated report identifiers 108a, . . . , 108N, respectively, are accessed by the report processing service 104 and from the storage repository 107.

The method 300 proceeds from 302 to 304. At 304 of the method 300, the report processing service 104 translates description of one or more reports to a common language. For example, the report processing service 104 may include or otherwise access a language model 105 (see FIG. 1) for this translation operation. The language model 105 may be a machine learning (ML) model trained for such translation operation. In an example, a small language model (SLM) may be used, while in another example a large language model (LLM) may be used for the language model 105. Thus, descriptions of reports 110a, . . . , 110N are translated to a common language (such as English for an organization based within an English-speaking country). For example, in a large organization spanning over multiple offices, multiple geographical areas, and/or multiple countries, various languages for submission may be available. Merely as an example, in FIG. 2A, description for reports 110a, 110b, 110d, and 110N are in English, while description for report 110c is in Germany. Accordingly, descriptions in possibly different languages may be standardized to a common language at 304 of method 300. For example, an i^{th} report may include a description Dᵢ. The description Dᵢ may be converted to a common language Dᵢ^{common} using a translation operation TRANSLATE ( . . . ) and added to a table T that includes the descriptions in the common language. This can be represented as follows:

For description Dᵢ of i^{th} report:

Dᵢ^{common}=TRANSLATE(Di);T←T∪Dᵢ^{common}. Equation 1

Thus, Dᵢ^{common}=TRANSLATE (Dᵢ) translates description Dᵢ to a common language description Dᵢ^{common}. Here ∪ is the union operation, as Dᵢ^{common} is added to the report table T (e.g., table T updated with the translated description Dᵢ^{common} for the i^{th} report). The operation TRANSLATE ( . . . ) for translation may be performed by the language model 105. In an example, one or more other attributes of the report may be converted into a description, where the description may include expense attributes, such as location, hotel, air trip, meals, etc., specified in a standardized format (such as JavaScript Object Notation or JSON format).

The method 300 proceeds from 304 to 308. At 308, the report processing service 104 detects a number of participants associated with events of each report. For example, some reports may be pre-populated with the associated number of participants (e.g., report 110b of FIG. 2A). In another example, some other reports may not be pre-populated with the associated number of participants (e.g., reports 110A, 110c, 110d, 110N of FIG. 2A). The report processing service 104 may communicate with the language model 105, which may parse the description to determine a number of participants associated with events of individual reports. The language model 105 processes a report (such as a description associated with the report) using an operation PARTICIPANT ( . . . ), to determine a number Pi representative of a number of participants in an associated event of an i^{th} report. This can be represented as:

Pᵢ=PARTICIPANT(Dᵢ^{common});T←T∪Pᵢ. Equation 2

Thus, Pᵢ=PARTICIPANT (Dᵢ^{common}) determines, from the translated description Dᵢ^{common} of an i^{th} report, a number of participants associated with an event of the i^{th} report. The number of participants Pᵢ is added to the table (e.g., T←T∪Pᵢ). The operation PARTICIPANT ( . . . ) for detecting the number of participants may be performed by the language model 105.

The method 300 proceeds from 308 to 312. At 312, the report processing service 104 detects a number of days of events of each report. For example, some reports may be pre-populated with the associated number of days (e.g., report 110b of FIG. 2A). In another example, some other reports may not be pre-populated with the associated number of days (e.g., reports 110A, 110c, 110d, 110N of FIG. 2A). In an example, the number of days may be more relevant to those reports for which the underlying event occurred over a period of multiple days, such as a hotel stay.

The report processing service 104 may communicate with the language model 105, which may parse the descriptions (e.g., unless the report explicitly indicates a number of days) to determine a number of days associated with events of individual reports. The language model 105 processes a report (such as an associated description) using an operation DAY ( . . . ), to determine a number Dayᵢ representative of a number of days in an associated event of an i^{th} report. This can be represented as:

Dayᵢ=DAY(Dᵢ^{common});T←T∪Dayᵢ. Equation 3

Thus, Dayᵢ=DAY (Dᵢ^{common}) determines, from the translated description Dᵢ^{common} of an i^{th} report, a number of days associated with an event of the i^{th} report. The number of days Dayᵢ is added to the table (e.g., T←T∪Dayᵢ). The operation DAY ( . . . ) for detecting the number of days may be performed by the language model 105.

The method 300 proceeds from 312 to 316. At 316, the report processing service 104 detects a type of event for each report. For example, some reports may be pre-populated with associated type of events (e.g., reports 110b, 110N of FIG. 2A). In another example, some other reports may not be pre-populated with associated type of events (e.g., reports 110A, 110c, 110d of FIG. 2A).

The report processing service 104 may communicate with the language model 105, which may parse the associated description (e.g., unless the report explicitly indicates a type of event) to determine a type of event of individual reports. The language model 105 processes a report (such as an associated description) using an operation TYPE ( . . . ), to determine Typeᵢ representative of a type of event for an i^{th} report. This can be represented as:

Typeᵢ=TYPE(Dᵢ^{common});T←T∪Typeᵢ. Equation 4

Thus, Typeᵢ=TYPE (Dᵢ^{common}) determines, from the translated description Dᵢ^{common} of an i^{th} report, a type of the event of the i^{th} report. The type of the event Typeᵢ is added to the table (e.g., T←T∪Typeᵢ). The operation TYPE ( . . . ) for detecting the type of event may be performed by the language model 105.

The method 300 proceeds from 316 to 320. At 320, the report processing service 104 detects one or more other attributes for each report (e.g., using techniques at least in part similar to those described above with respect to equations 1-4). Examples of such attributes may include, for example, (i) a location in which an event associated with a report occurred, (ii) a position of the person incurring the expense (e.g., a high-level employee, such as an executive of an organization may have a higher budget for accommodation and travel compared to that of a low-level employee), (iii) a budget that was pre-authorized for an event, (iv) company policies associated with related events, (v) a currency code (e.g., USD, Canadian dollar (CAD), Euro (EUR), etc.) in which the expense incurred, and/or (vi) other relevant information that may facilitate in detecting anomalous reports.

The method 300 proceeds from 320 to 324. At 324, the report processing service 104 outputs processed reports 112a, 112b, . . . , 112N associated with the report identifiers 108a, 108b, . . . , 108N, as also illustrated in FIG. 1.

FIG. 3B illustrates a process flow for processing (e.g., by the report processing service 104) a report 110i, to generate a corresponding processed report 112i. For example, the report processing service 104 receives a report 110i of the plurality of reports 110a, . . . , 110N. In an example, one or more attributes of the report 110i may not be populated (such as the number of people and the number of days for the report 110a are not populated in FIG. 2A).

The report processing service 104 transmits a description Di of the report 110i, along with a prompt specifying one or more missing attributes of the report 110i, to the language model 105. The language model 105 extracts the one or more missing attributes from the description Di of the report 110i, e.g., as described above with respect to equations 1-4. The language model 105 transmits the missing attributes 340i, 342, . . . , 350i to the report processing service 104. The report processing service 104 updates the missing attributes 340i, 342i, . . . , 350i within the report 110i, to generate a corresponding processed report 112i, e.g., as also described above with respect to equations 1-4. Accordingly, an updated report table T has the processed report 112i. The report processing service 104 repeats this process for reports having one or more missing attributes, to generate an updated table comprising the processed reports 112a, . . . , 112N.

FIG. 2B illustrates a table 250 including processed reports 112a, 112b, . . . , 112N associated with the report identifiers 108a, 108b, . . . , 108N. The processed reports 112a, 112b, . . . , 112N may be output by the report processing service 104 at 324. For example, the processed report 112a corresponding to the report identifier 108a is generated by processing the report 110a, the processed report 112b corresponding to the report identifier 108b is generated by processing the report 110b, and so on.

For example, comparing the tables 200 and 250 of FIGS. 2A and 2B, respectively, the description of the report 110c in FIG. 2A was in Germany, which the report processing service 104 translated to English in the processed report 112c in FIG. 2B (e.g., in accordance with equation 1 described above).

Similarly, for example, the report 110a in FIG. 2A lacked a number of participants for the event, which the report processing service 104 populated in the processed report 112a in FIG. 2B (e.g., in accordance with equation 2 described above).

Similarly, for example, the report 110c in FIG. 2A lacked a number of days of the event, which the report processing service 104 populated in the processed report 112c in FIG. 2B (e.g., in accordance with equation 3 described above).

Similarly, for example, the report 110c in FIG. 2A lacked a type of event, which the report processing service 104 populated in the processed report 112c in FIG. 2B (e.g., in accordance with equation 4 described above).

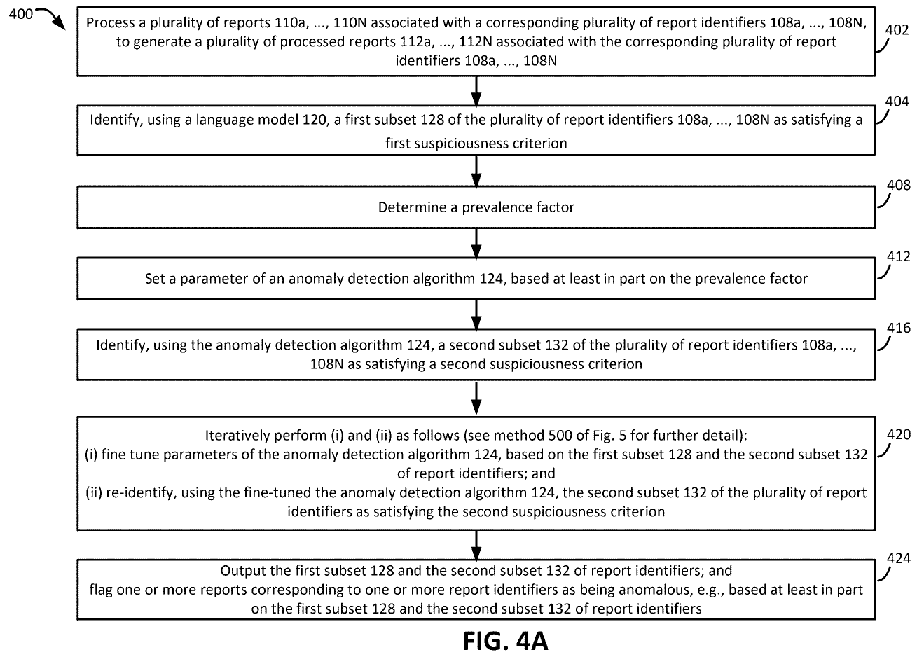

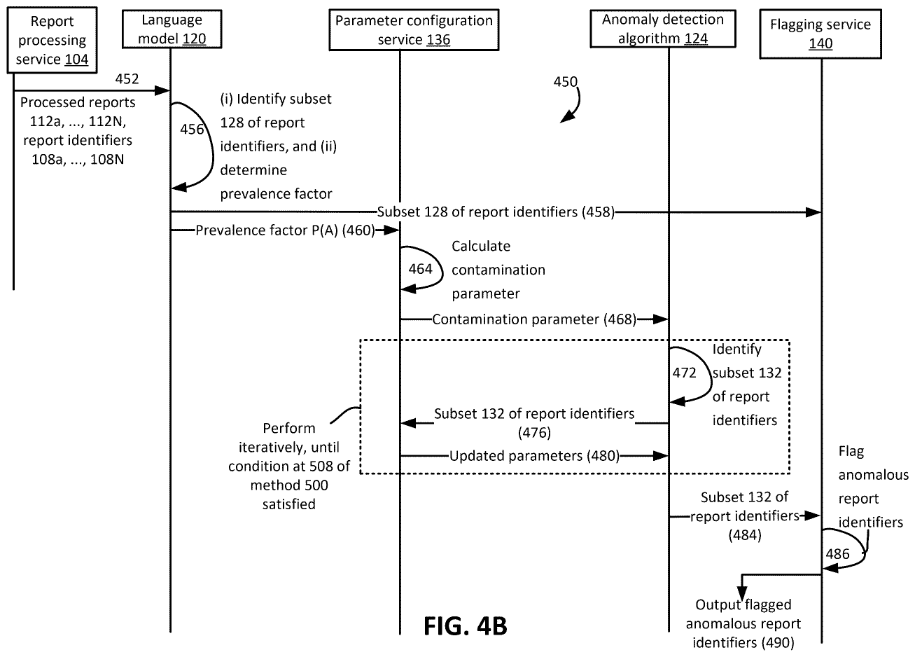

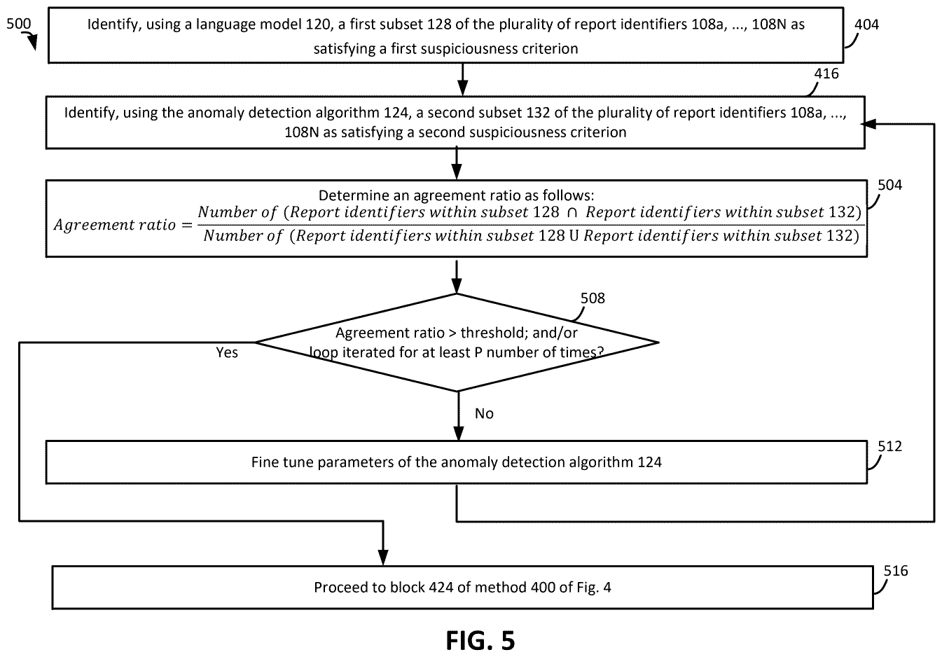

FIG. 4A illustrates a flowchart depicting a method 400 for detecting anomalous reports. FIG. 4B illustrates a process flow 450 for detecting anomalous reports. The method 400 may be performed by the anomaly detection system 100 of FIG. 1. The method 400 of FIG. 4A and the process flow 450 of FIG. 4B will be described in unison.

While various blocks of the method 400 are shown in a particular order, the order may be modified. For example, some blocks may be performed before others, while some blocks may be performed simultaneously. In an example, execution of some of the blocks may be optional.

At 402 of the method 400, a plurality of reports associated with a corresponding plurality of report identifiers are processed (e.g., by the report processing service 104), to generate a plurality of processed reports associated with the corresponding plurality of report identifiers. For example, processed reports 112a, . . . , 112N associated with the corresponding plurality of report identifiers 108a, . . . , 108N are generated from the plurality of reports 110a, . . . , 110N associated with the corresponding plurality of report identifiers 108a, . . . , 108N, e.g., as described above with respect to FIGS. 2A, 2B, and 3A. As illustrated in FIG. 4B, the processed reports 112a, . . . , 112N, along with the report identifiers 108a, . . . , 108N, are provided to the language model 120 from the report processing service 104 at 452.

The method 400 proceeds from 402 to 404. At 404, using a language model 120 (see FIG. 1), a first subset 128 of the plurality of report identifiers are identified as satisfying a first suspiciousness criterion of the language model 120. Similar identification of the first subset 128 of the plurality of report identifiers is also as 456 in FIG. 4B.

The language model 120 and the language model 105 (illustrated in FIG. 1) may be the same or may be different. In an example, the language model 120 may be a SLM, while in another example, the language model 120 may be an LLM. In an example, the language model 120 may be pretrained to identify report identifiers that satisfy a suspiciousness criterion. For example, if the language model 120 estimates a processed report associated with a corresponding report identifier as being possibly anomalous, then the suspiciousness criterion of the language model 120 is fulfilled and the language model 120 adds the corresponding report identifier to the first subset 128.

Thus, the language model 120 reviews each of processed reports 112a, 112b, . . . , 112N. If the language model 120 estimates a processed report to be possibly anomalous (e.g., satisfying the first suspiciousness criterion of the language model 120), the language model 120 adds the corresponding report identifier to the identified first subset 128.

Merely as an example, the language model 120 may not identify the processed report 112a as satisfying the suspiciousness criterion, because dinner for two (one of which may be a high valued client) at San Francisco (which is known for its high cost of living and expensive restaurants) may be reasonable. In contrast, the processed report 110b for a work lunch between two participants in Wheeler County, Oregon may satisfy the suspiciousness criterion, because Wheeler County is a rural county in Oregon and has a relatively low cost of living (e.g., compared to San Francisco). Accordingly, $500 for the expense captured in the report 110b may be too excessive and may possibly be anomalous. Accordingly, for these examples, the language model 120 may include the report identifier 108b within the first subset 128, without including the report identifier 108a within the first subset 128.

The method 400 proceeds from 404 to 408. At 408, a prevalence factor P(A) is determined. In an example, the prevalence factor P(A) is based at least in part on the first subset 128 of the plurality of report identifiers 108a, . . . , 108N, where the first subset 128 has been identified as being satisfying the suspiciousness criterion of the language model 120, as described above.

In an example, a number of report identifiers within the first subset 128 is a given percentage or ratio of a number of report identifiers within the plurality of report identifiers 108a, . . . , 108N. In an example, the prevalence factor P(A) is based on this given percentage or ratio. For example, the prevalence factor P(A) is indicative of expected prevalence of anomalies within the plurality of reports being considered. As an example, the prevalence factor P(A) is calculated as follows:

Prevalence factor P(A)=sum(Ai)/N, Equation 5

where N is a total number of report identifiers 108a, . . . , 108N (and hence total number of reports 110a, . . . , 110N) being considered. Ai is an i^{th} anomaly label assigned to report identifiers within the first subset 128, and hence, sum(Ai) is a total number of report identifiers within the first subset 128.

As seen in equation 5, the prevalence factor P(A) is based on a ratio of sum(Ai) and N, and may be expressed as a ratio, a decimal, a fraction, and/or a percentage. Thus, in an example, the prevalence factor P(A) may be normalized.

However, in another example (and contrary to equation 5), the prevalence factor P(A) may simply be the sum(Ai), e.g., the number of report identifiers within the first subset 128.

Thus, merely as an example, if there are 2000 total reports being considered by the anomaly detection system 100 (e.g., N=2000) and the language model 120 identifies 100 reports to be suspicious, then the language model 120 includes 100 corresponding report identifiers in the first subset 128. Accordingly, for this example, the prevalence factor P(A) is 100/2000 or 0.05. In an example, the prevalence factor P(A) may be expressed as a percentage. Accordingly, for the above example use case, the prevalence factor P(A) is about 5%.

For example, FIG. 4B illustrates determination of the prevalence factor P(A) at 456. Although FIG. 4B illustrates the prevalence factor P(A) being determined by the language model 120, in an example, the prevalence factor P(A) may also be determined by one or more other components, such as the parameter configuration service 136. In any case (e.g., irrespective of whether the prevalence factor P(A) is determined by the parameter configuration service 136 or by the language model 120), the prevalence factor P(A) is received by the parameter configuration service 136 at 460 (see FIG. 4B). Also, the language model 120 transmits the identified first subset 128 of report identifiers to the flagging service 140 at 458.

The method 400 proceeds from 408 to 412. At 412, a parameter of an anomaly detection algorithm 124 (see FIG. 1) is set, based at least in part on the prevalence factor. The anomaly detection algorithm 124 is included within, or at least accessed by, the anomaly detection system 100. The anomaly detection algorithm 124 is different from the language model 120. For example, the anomaly detection algorithm 124 may use different techniques for detection of anomalies within the processed reports 112a, . . . , 112N, which are different from techniques used by the pre-trained language model 120.

In an example, the anomaly detection algorithm 124 is an isolation forest. Isolation forest is an unsupervised machine learning algorithm used for anomaly detection. For example, isolation forest identifies outliers within a dataset. In another example, another anomaly detection algorithm may also be used.

The anomaly detection algorithm 124 may have a plurality of user configurable parameters. In an example where the anomaly detection algorithm 124 is isolation forest, a contamination parameter is a user configurable parameter. The contamination parameter in isolation forest specifies a proportion of the dataset that the user expects to be anomalies or outliers. Merely as an example, if the contamination parameter in isolation forest is set to 3%, the isolation forest aims to find about 3% of the processed reports as being anomalous. Thus, the contamination parameter represents an expected fraction of anomalies in the dataset. Isolation forest uses the contamination parameter to set an anomaly score threshold, where the isolation forest decides the cutoff between normal and anomalous reports.

In an example, the anomaly detection system 100 aims that the anomaly detection algorithm 124 identifies anomalies at the approximate rate found by the language model 120. Accordingly, in an example, the prevalence factor P(A) (see equation 5 above) may be used to set a parameter of the anomaly detection algorithm 124. For example, the prevalence factor P(A) may be used to configure the contamination parameter of the isolation forest.

In an example, the contamination parameter is a function of the prevalence factor P(A), such as:

Contamination parameter=function of (prevalence factor P(A)). Equation 6

For example, a user of the anomaly detection system 100 may decide to make the contamination parameter equal to, somewhat greater than, or somewhat less than the prevalence factor P(A). In an example where the contamination parameter is configured to be equal to the prevalence factor P(A), the following holds:

Contamination parameter=prevalence factor P(A). Equation 7

In an example, a parameter configuration service 136 of the anomaly detection system 100 receives the prevalence factor P(A) and sets the contamination parameter in accordance with equations 6 and/or 7. For example, in FIG. 4B, at 464, the parameter configuration service 136 calculates the contamination parameter, and transmits the contamination parameter to the anomaly detection algorithm 124 at 468, to allow the anomaly detection algorithm 124 to set its contamination parameter accordingly.

The method 300 proceeds from 412 to 416. At 416, using the anomaly detection algorithm 124, a second subset 132 (see FIG. 1) of the plurality of report identifiers 108a, . . . , 108N are identified as satisfying a second suspiciousness criterion. For example, FIG. 4B illustrates the anomaly detection algorithm 124 identifying at 472 the second subset 132 of the plurality of report identifiers 108a, . . . , 108N.

For example, if the anomaly detection algorithm 124 estimates a processed report associated with a corresponding report identifier as being possibly anomalous, then the second suspiciousness criterion of the anomaly detection algorithm 124 is fulfilled, and the anomaly detection algorithm 124 adds the corresponding report identifier to the second subset 132.

Thus, the anomaly detection algorithm 124 reviews each of processed reports 112a, 112b, . . . , 112N. If the anomaly detection algorithm 124 estimates a processed report to be possibly anomalous (e.g., satisfying the second suspiciousness criterion of the anomaly detection algorithm 124), the anomaly detection algorithm 124 adds the corresponding report identifier to the identified second subset 132.

Note that the contamination parameter of the anomaly detection algorithm 124 is set in accordance with equations 6 and/or 7 above. Accordingly, the anomaly detection algorithm 124 may aim to keep a number of report identifiers within the second subset 132 to be in the range of (such as somewhat equal to) a number of report identifiers within the first subset 128.

Thus, the number of report identifiers within the first subset 128 and the second subset 132 may be in the same range (e.g., within 10%, or 5%, or 3%, or 2%, or 1% of each other). However, the actual report identifiers within the first subset 128 and the second subset 132 may not exactly match. For example, after operation 416, the first subset 128 may include report identifiers 108d, 108e, 108f, whereas the second subset 132 may include report identifiers 108e, 108g, 108h. Thus, although the first subset 128 and the second subset 132 have the same number (e.g., three) of report identifiers, only one report identifier within the first subset 128 and the second subset 132 match. As described below in further detail, the anomaly detection system 100 tunes the anomaly detection algorithm 124, aiming to have a higher degree of agreement between the first subset 128 and the second subset 132.

The method 400 proceeds from 416 to 420. At 420, operations (i) and (ii) are performed iteratively. Operation (i) comprises fine tuning parameters of the anomaly detection algorithm 124 (e.g., by the parameter configuration service 136), e.g., based on the first subset 128 and the second subset 132 of report identifiers. Operation (ii) comprises re-executing the fine-tuned anomaly detection algorithm 124, to re-identify and update the second subset 132 of report identifiers. Operations 420 of method 400 including operations (i) and (ii) are described below in further detail with respect to method 500 of FIG. 5.

Similarly, for example, FIG. 4B illustrates the anomaly detection algorithm 124 identifying the subset 132 of report identifiers at 472, transmitting the subset 132 to the parameter configuration service 136 at 476, and the parameter configuration service 136 transmitting fine-tuned and updated parameters of the anomaly detection algorithm 124 back to the anomaly detection algorithm 124 for updating, and iteratively repeating processes 472, 476, and 480 iteratively, until a condition 508 of method 500 (described below) is satisfied.

Thus, at the end of 420, (i) the language model 120 identifies one or more report identifiers within the first subset 128 as satisfying a first suspiciousness criterion of the language model 120 (404 of method 400), and (ii) the anomaly detection algorithm 124 identifies one or more report identifiers within the second subset 132 as satisfying a second suspiciousness criterion of the anomaly detection algorithm 124.

The method 400 proceeds from 420 to 424. At 424, the first subset 128 and the second subset 132 are output, e.g., to a flagging service 140 (illustrated as 458 and 484 in FIG. 4B). Furthermore, one or more reports corresponding to one or more report identifiers are flagged as being anomalous, e.g., based at least in part on the first subset 128 and the second subset 132 of report identifiers (e.g., illustrated as 486 in FIG. 4B). For example, the anomaly detection system 100 comprises the flagging service 140 that flags one or more reports corresponding to one or more report identifiers within the first subset 128 and/or the second subset 132 as being anomalous.

There may be multiple ways in which report identifiers and associated reports may be flagged as being anomalous. For example, an i^{th} report corresponding to an i^{th} report identifier can be flagged as being anomalous if the following condition is satisfied:

$$Expense report i is flagged as :$$

$$\{ \begin{matrix}\begin{matrix}( i ) anomalous , if ith report indentifier is in first \\ subset 128 and second subset 132 ,\end{matrix} \\ ( ii ) not anomalous , otherwise\end{matrix} \qquad Equation 8$$

Thus, in accordance with equation 8, an i^{th} report is flagged as being anomalous, if a corresponding i^{th} report identifier is included in both the first subset 128 and the second subset 132 of the report identifiers. Thus, if a report identifier satisfies the suspiciousness criterion of the language model 120 and the suspiciousness criterion of the anomaly detection algorithm 124, the corresponding report is flagged as being anomalous. In the example of equation 8, if a report identifier satisfies only one (or does not satisfy any of) of (i) the suspiciousness criterion of the language model 120 and (ii) the suspiciousness criterion of the anomaly detection algorithm 124, then the corresponding report is not flagged as being anomalous.

In another example, flagging of report identifiers are performed as follows:

$$Expense report i is flagged as :$$

$$\{ \begin{matrix}\begin{matrix}\begin{matrix}\begin{matrix}( i ) anomalous with high confidence \\ \begin{matrix}if ith report identifier is in first subset 128 and \\ second subset 132\end{matrix}\end{matrix} \\ ( ii ) anomalous with low confidence ,\end{matrix} \\ \begin{matrix}if ith report indentifier is in exactly one of \\ ( first subset 128 and second subset 132 )\end{matrix}\end{matrix} \\ ( iii ) not anomalous , otherwise\end{matrix} \qquad Equation 9$$

Thus, in accordance with equation 9, multiple levels of flagging as being anomalous may be possible. For example, the flagging service 140 flags an i^{th} report as being anomalous with a high confidence level, if the corresponding i^{th} report identifier is in both the first subset 128 and the second subset 132 of report identifiers. Thus, if a report identifier satisfies the suspiciousness criterion of the language model 120 and the suspiciousness criterion of the anomaly detection algorithm 124, the corresponding report is flagged as being anomalous with high confidence level.

On the other hand, for example, the flagging service 140 flags an i^{th} report as being anomalous with a low confidence level, if the corresponding i^{th} report identifier is in exactly one of the first subset 128 and the second subset 132 of report identifiers. Thus, if a report identifier satisfies the suspiciousness criterion of any one of (i) the language model 120 and (ii) the anomaly detection algorithm 124, the corresponding report is flagged as being anomalous with low confidence level.

Finally, for example, the flagging service 140 does not flag an i^{th} report as being anomalous, if the corresponding i^{th} report identifier is neither in the first subset 128 nor the second subset 132 of report identifiers. Thus, if a report identifier does not satisfy the suspiciousness criterion of any of the language model 120 and the anomaly detection algorithm 124, the corresponding report is not flagged as being anomalous.

For example, FIG. 4B illustrates the flagging service 140 outputting one or more flagged anomalous report identifiers at 490.

Once a report is flagged as being anomalous, one or more mitigating actions may be undertaken. For example, reimbursement of the flagged report may be denied. In another example, the flagged report may be reviewed manually by a human resource employee. In yet another example, a submitter of the flagged report may be asked for further explanation regarding an anomaly in the report. Such mitigating actions may be implementation specific and may vary from one implementation to the next.

FIG. 5 illustrates a flowchart depicting a method 500 for fine tuning an anomaly detection algorithm (such as the anomaly detection algorithm 124 of FIG. 1), based on (i) a first subset 128 of report identifiers that satisfies a first suspiciousness criterion of a language model 120 and (ii) a second subset 132 of report identifiers that satisfies a second suspiciousness criterion of the anomaly detection algorithm. More specifically, the method 500 at least in part, discusses the block 420 of the method 400 of FIG. 4A in further detail. In an example, at least a part of the method 500 is executed by the parameter configuration service 136. While various blocks of the method 500 are shown in a particular order, the order may be modified. For example, some blocks may be performed before others, while some blocks may be performed simultaneously. In an example, execution of some of the blocks may be optional.

At 404 of method 500, using a language model 120, a first subset 128 of the plurality of report identifiers are identified as satisfying a first suspiciousness criterion of the language model 120, as also described above with respect to FIG. 4A.

The method 500 proceeds from 404 to 416. Note that there are intermediate operations between 404 and 416, which are described above with respect to FIG. 4A. At 416, using the anomaly detection algorithm 124, a second subset 132 of the plurality of report identifiers 108a, . . . , 108N are identified as satisfying a second suspiciousness criterion of the anomaly detection algorithm 124.

The method 500 proceeds from 416 to 504. At 504, the report identifiers within the first subset 128 and the report identifiers within the second subset 132 are used to determine an agreement ratio. For example, the parameter configuration service 136 identifies unique reports identifiers that are within both the first subset 128 and the second subset 132, e.g., represented herein as “Report identifiers with subset 128 ∩ Report identifiers with subset 132.” This is the union (represented as “∩”) of report identifiers within subset 128 and report identifiers within subset 132. The parameter configuration service 136 then determines a number of unique reports identifiers that are within both the first subset 128 and the second subset 132, e.g., represented herein as “Number of (report identifiers with subset 128 ∩ report identifiers with subset 132).”

Also, the parameter configuration service 136 identifies unique reports identifiers that are within at least one of the first subset 128 and the second subset 132, e.g., represented herein as “Report identifiers within subset 128 ∪ Report identifiers within subset 132.” This is the intersection (represented as “U”) of report identifiers within subset 128 and report identifiers within subset 132. The parameter configuration service 136 then determines a number of unique reports identifiers that are within at least one of the first subset 128 and the second subset 132, e.g., represented herein as “Number of (report identifiers within subset 128 ∪ report identifiers within subset 132).”

The parameter configuration service 136 then determines an agreement ratio of (i) the number of (report identifiers within subset 128 ∩ report identifiers within subset 132) and (ii) the number of (report identifiers within subset 128 ∪ report identifiers within subset 132). Thus:

$$Agreement ratio = \frac{number of ( \begin{matrix}report identifiers within subset 128 ⋂ \\ report identifiers within subset 132\end{matrix} )}{number of ( \begin{matrix}report identifiers within subset 128 ⋃ \\ report identifiers within subset 132\end{matrix} )} . \qquad Equation 10$$

For example, if the anomaly detection algorithm 124 is configured correctly or optimally (or at least sub-optimally), the anomalies detected by the language model 120 and the anomaly detection algorithm 124 may agree at a relatively high rate, thereby resulting in a relatively higher value of the agreement ratio. On the other hand, if the anomaly detection algorithm 124 is not configured as desired, there may be high disagreement between the language model 120 and the anomaly detection algorithm 124, resulting in a relatively lower value of the agreement ratio. The goal here is to tune parameters of the anomaly detection algorithm 124, such that anomalies detected by the language model 120 and the anomaly detection algorithm 124 agree at a relatively high rate, thereby resulting in a relatively higher value of the agreement ratio.

The method 500 proceeds from 504 to 508. At 508, the parameter configuration service 136 determines whether the agreement ratio is greater than a threshold, and/or whether a loop of method 500 has been iterated for at least a threshold number (such as P number) of times. If the agreement ratio is greater than the configurable threshold, this implies that the anomaly detection algorithm 124 is satisfactorily configured, such that anomalies detected by the language model 120 and the anomaly detection algorithm 124 agree at a relatively high rate (e.g., higher than the threshold). The threshold may be, merely as an example, set to 0.5, or 0.6, or 07, or 0.8, or another appropriate value. Also, the condition “loop iterated for at least P number of times?” reduces chances of the loop in method 500 being repeated indefinitely, in case the agreement ratio remains lower than the threshold even after multiple iterations.

If the conditions at 508 are not satisfied (e.g., agreement ratio<threshold, and loop not iterated for at least P number of times) and it is a “No” at 508, the method 500 proceeds from 508 to 512, where one or more parameters of the anomaly detection algorithm 124 are fine tuned. Fine tuning the parameters of the anomaly detection algorithm 124 is performed, with a goal of achieving a higher agreement between anomalies detected by the language model 120 and the anomaly detection algorithm 124. For example, a goal of fine tuning the parameters of the anomaly detection algorithm 124 is to maximize the agreement ratio, such as to maximize the following:

$$max \frac{Number of ( \begin{matrix}Report identifiers within subset 128 ⋂ \\ Report identifiers within subset 132\end{matrix} )}{Number of ( \begin{matrix}Report identifiers within subset 128 ⋃ \\ Report identifiers within subset 132\end{matrix} )} . \qquad Equation 11$$

Any one or more appropriate parameters of the anomaly detection algorithm 124 may be fine-tuned, such as the contamination parameter and/or one or more other parameters. In the example where the anomaly detection algorithm 124 is isolation forest, an example parameter may include n_estimators, which may be representative of a number of individual isolation trees within the isolation forest. Increasing the number of trees may improve accuracy and stability, but at increased computational cost.

Another example parameter that may be fine-tuned may include max_samples (e.g., subsampling size). This parameter may specify a number of samples to draw from a training data for each isolation tree. Smaller subsamples can reduce computational costs and potentially improve performance on imbalanced datasets, while larger subsamples may result in relatively better overall performance on larger datasets.

Another example parameter that may be fine-tuned may include max_features (e.g., number of features). This parameter determines a number of features to consider for splitting at each node in the isolation trees. Using fewer features may reduce chances of overfitting and improve model efficiency, e.g., on high-dimensional datasets.

Another example parameter that may be fine-tuned may include threshold (e.g., an outlier score threshold). This parameter defines a threshold above which data points are flagged as outliers based on their isolation score. Adjusting the threshold allows to tune a sensitivity of isolation forest to outliers.

Another example parameter that may be fine-tuned may include whether to enable bootstrap samples. This parameter controls whether the subsamples for each tree are drawn with or without replacement. Bootstrap sampling may introduce variability and improve a robustness of isolation forest.

The method 500 loops back from 512 to 416, where the fine-tuned anomaly detection algorithm 124 is reused to re-identify the second subset 132 of the plurality of report identifiers 108a, . . . , 108N as satisfying the second suspiciousness criterion. This way, the method 500 loops iteratively, to improve an accuracy of the anomaly detection algorithm 124. By fine-tuning the one or more parameters and/or settings of the anomaly detection algorithm 124, the parameter configuration service 136 aims to increase the agreement between anomalies detected by the language model 120 and the anomaly detection algorithm 124, e.g., to ensure that both models agree on the classification of anomalous reports for a significant portion of the dataset.

However, if “Yes” at 508 (e.g., if the agreement ratio is higher than the threshold and/or the loop has been iterated for at least a threshold P number of times, where P can be 2, or 3, or 4, or 5, or a higher number), the method 500 proceeds from 508 to 516. At 516, the method 500 proceeds to block 424 of method 400 of FIG. 4A, which has been described above in detail.

### Computer System Architecture

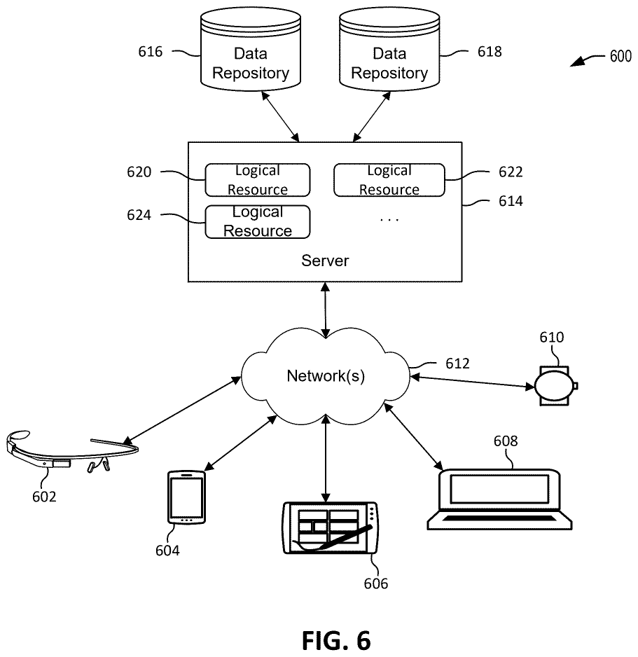

FIG. 6 depicts a simplified diagram of a distributed system 600 for implementing an embodiment. In the illustrated embodiment, distributed system 600 includes one or more client computing devices 602, 604, 606, 608, and/or 610 coupled to a server 614 via one or more communication networks 612. Clients computing devices 602, 604, 606, 608, and/or 610 may be configured to execute one or more applications.

In various aspects, server 614 may be adapted to run one or more services or software applications that enable techniques for detection of anomalous reports.

In certain aspects, server 614 may also provide other services or software applications that can include non-virtual and virtual environments. In some aspects, these services may be offered as web-based or cloud services, such as under a Software as a Service (SaaS) model to the users of client computing devices 602, 604, 606, 608, and/or 610. Users operating client computing devices 602, 604, 606, 608, and/or 610 may in turn utilize one or more client applications to interact with server 614 to utilize the services provided by these components.

In the configuration depicted in FIG. 6, server 614 may include one or more components 620, 622 and 624 that implement the functions performed by server 614. These components may include software components that may be executed by one or more processors, hardware components, or combinations thereof. It should be appreciated that various different system configurations are possible, which may be different from distributed system 600. The embodiment shown in FIG. 6 is thus one example of a distributed system for implementing an embodiment system and is not intended to be limiting.

Users may use client computing devices 602, 604, 606, 608, and/or 610 for techniques for detection of anomalous reports, in accordance with the teachings of this disclosure. A client device may provide an interface that enables a user of the client device to interact with the client device. The client device may also output information to the user via this interface. Although FIG. 6 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 612 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 612 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 614 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 614 can include one or more virtual machines running virtual operating systems, or other computing architectures involving virtualization such as one or more flexible pools of logical storage devices that can be virtualized to maintain virtual storage devices for the server. In various aspects, server 614 may be adapted to run one or more services or software applications that provide the functionality described in the foregoing disclosure.

The computing systems in server 614 may run one or more operating systems including any of those discussed above, as well as any commercially available server operating system. Server 614 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 614 may include one or more applications to analyze and consolidate data feeds and/or event updates received from users of client computing devices 602, 604, 606, 608, and/or 610. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 614 may also include one or more applications to display the data feeds and/or real-time events via one or more display devices of client computing devices 602, 604, 606, 608, and/or 610.

Distributed system 600 may also include one or more data repositories 616, 618. These data repositories may be used to store data and other information in certain aspects. For example, one or more of the data repositories 616, 618 may be used to store information for techniques for detection of anomalous reports. Data repositories 616, 618 may reside in a variety of locations. For example, a data repository used by server 614 may be local to server 614 or may be remote from server 614 and in communication with server 614 via a network-based or dedicated connection. Data repositories 616, 618 may be of different types. In certain aspects, a data repository used by server 614 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 616, 618 may also be used by applications to store application data. The data repositories used by applications may be of different types such as, for example, a key-value store repository, an object store repository, or a general storage repository supported by a file system.

In one embodiment, server 614 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

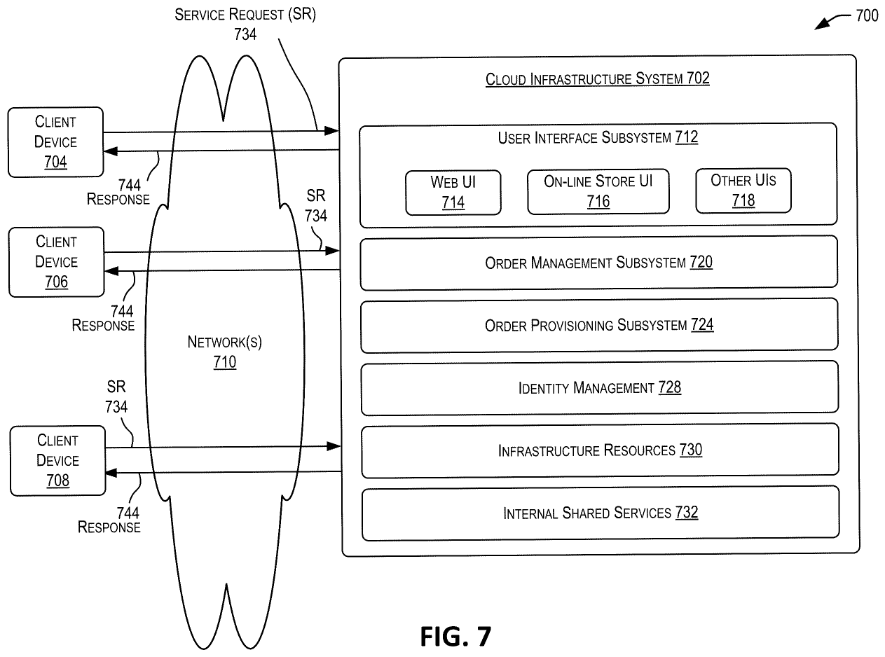

FIG. 7 is a simplified block diagram of a cloud-based system environment 700 in which techniques for detection of anomalous reports are detected, in accordance with certain aspects. In the embodiment depicted in FIG. 7, cloud infrastructure system 702 may provide one or more cloud services that may be requested by users using one or more client computing devices 704, 706, and 708. Cloud infrastructure system 702 may comprise one or more computers and/or servers that may include those described above for server 614. The computers in cloud infrastructure system 702 may be organized as general purpose computers, specialized server computers, server farms, server clusters, or any other appropriate arrangement and/or combination.

Network(s) 710 may facilitate communication and exchange of data between clients 704, 706, and 708 and cloud infrastructure system 702. Network(s) 710 may include one or more networks. The networks may be of the same or different types. Network(s) 710 may support one or more communication protocols, including wired and/or wireless protocols, for facilitating the communications.

The embodiment depicted in FIG. 7 is only one example of a cloud infrastructure system and is not intended to be limiting. It should be appreciated that, in some other aspects, cloud infrastructure system 702 may have more or fewer components than those depicted in FIG. 7, may combine two or more components, or may have a different configuration or arrangement of components. For example, although FIG. 7 depicts three client computing devices, any number of client computing devices may be supported in alternative aspects.

The term cloud service is generally used to refer to a service that is made available to users on demand and via a communication network such as the Internet by systems (e.g., cloud infrastructure system 702) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 710 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 702 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 702 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 702. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 702. Cloud infrastructure system 702 then performs processing to provide the services requested in the tenant's subscription order. Cloud infrastructure system 702 may be configured to provide one or even multiple cloud services.

Cloud infrastructure system 702 may provide the cloud services via different deployment models. In a public cloud model, cloud infrastructure system 702 may be owned by a third party cloud services provider and the cloud services are offered to any general public tenant, where the tenant can be an individual or an enterprise. In certain other aspects, under a private cloud model, cloud infrastructure system 702 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 702 and the services provided may be shared by several organizations in a related community. Various other models such as hybrids of the above mentioned models may also be used.

Client computing devices 704, 706, and 708 may be of different types (such as devices 602, 604, 606, and 608 depicted in FIG. 6) and may be capable of operating one or more client applications. A user may use a client device to interact with cloud infrastructure system 702, such as to request a service provided by cloud infrastructure system 702.

In some aspects, the processing performed by cloud infrastructure system 702 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 702 for determining the intent of an utterance. The data used for this analysis may include structured data (e.g., data stored in a database or structured according to a structured model) and/or unstructured data (e.g., data blobs (binary large objects)).

As depicted in the embodiment in FIG. 7, cloud infrastructure system 702 may include infrastructure resources 730 that are utilized for facilitating the provision of various cloud services offered by cloud infrastructure system 702. Infrastructure resources 730 may include, for example, processing resources, storage or memory resources, networking resources, and the like.

In certain aspects, to facilitate efficient provisioning of these resources for supporting the various cloud services provided by cloud infrastructure system 702 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 702 may itself internally use services 732 that are shared by different components of cloud infrastructure system 702 and which facilitate the provisioning of services by cloud infrastructure system 702. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 702 may comprise multiple subsystems. These subsystems may be implemented in software, or hardware, or combinations thereof. As depicted in FIG. 7, the subsystems may include a user interface subsystem 712 that enables users of cloud infrastructure system 702 to interact with cloud infrastructure system 702. User interface subsystem 712 may include various different interfaces such as a web interface 714, an online store interface 716 where cloud services provided by cloud infrastructure system 702 are advertised and are purchasable by a consumer, and other interfaces 718. For example, a tenant may, using a client device, request (service request 734) one or more services provided by cloud infrastructure system 702 using one or more of interfaces 714, 716, and 718. For example, a tenant may access the online store, browse cloud services offered by cloud infrastructure system 702, and place a subscription order for one or more services offered by cloud infrastructure system 702 that the tenant wishes to subscribe to. The service request may include information identifying the tenant and one or more services that the tenant desires to subscribe to. For example, a tenant may place a subscription order for a chatbot related service offered by cloud infrastructure system 702. As part of the order, the client may provide information identifying the input (e.g. utterances).

In certain aspects, such as the embodiment depicted in FIG. 7, cloud infrastructure system 702 may comprise a service management subsystem (OMS) 720 that is configured to process the new order. As part of this processing, OMS 720 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 720 may then invoke the service provisioning subsystem (OPS) 724 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 724 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 702 may send a response or notification 744 to the requesting tenant to indicate when the requested service is now ready for use. In some instances, information (e.g., a link) may be sent to the tenant that enables the tenant to start using and availing the benefits of the requested services.

Cloud infrastructure system 702 may provide services to multiple tenants. For each tenant, cloud infrastructure system 702 is responsible for managing information related to one or more subscription orders received from the tenant, maintaining tenant data related to the orders, and providing the requested services to the tenant or clients of the tenant. Cloud infrastructure system 702 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 702 may provide services to multiple tenants in parallel. Cloud infrastructure system 702 may store information for these tenants, including possibly proprietary information. In certain aspects, cloud infrastructure system 702 comprises an identity management subsystem (IMS) 728 that is configured to manage tenant's information and provide the separation of the managed information such that information related to one tenant is not accessible by another tenant. IMS 728 may be configured to provide various security-related services such as identity services, such as information access management, authentication and authorization services, services for managing tenant identities and roles and related capabilities, and the like.

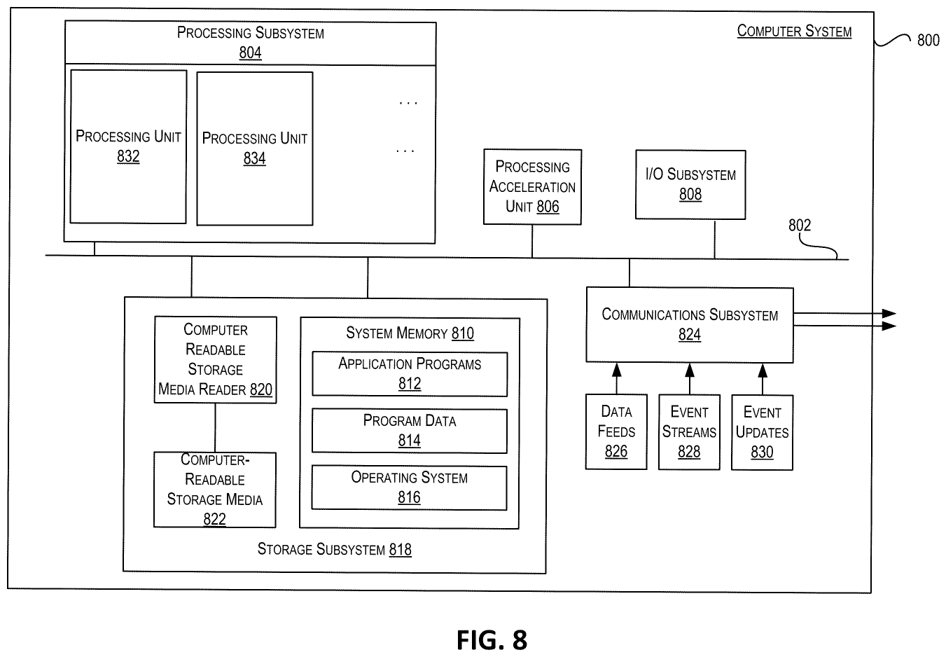

FIG. 8 illustrates an exemplary computer system 800 that may be used to implement certain aspects. As shown in FIG. 8, computer system 800 includes various subsystems including a processing subsystem 804 that communicates with a number of other subsystems via a bus subsystem 802. These other subsystems may include a processing acceleration unit 806, an I/O subsystem 808, a storage subsystem 818, and a communications subsystem 824. Storage subsystem 818 may include non-transitory and/or transitory computer-readable storage media including storage media 822 and a system memory 810.

Bus subsystem 802 provides a mechanism for letting the various components and subsystems of computer system 800 communicate with each other as intended. Although bus subsystem 802 is shown schematically as a single bus, alternative aspects of the bus subsystem may utilize multiple buses. Bus subsystem 802 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 804 controls the operation of computer system 800 and may comprise one or more processors, application specific integrated circuits (ASICs), or field programmable gate arrays (FPGAs). The processors may be single core or multicore processors. The processing resources of computer system 800 can be organized into one or more processing units 832, 834, etc. A processing unit may include one or more processors, one or more cores from the same or different processors, a combination of cores and processors, or other combinations of cores and processors. In some aspects, processing subsystem 804 can include one or more special purpose co-processors such as graphics processors, digital signal processors (DSPs), or the like. In some aspects, some or all of the processing units of processing subsystem 804 can be implemented using customized circuits, such as application specific integrated circuits (ASICs), or field programmable gate arrays (FPGAs).

In some aspects, the processing units in processing subsystem 804 can execute instructions stored in system memory 810 or on computer readable storage media 822. In various aspects, the processing units can execute a variety of programs or code instructions and can maintain multiple concurrently executing programs or processes. At any given time, some or all of the program code to be executed can be resident in system memory 810 and/or on computer-readable storage media 822 including potentially on one or more storage devices. Through suitable programming, processing subsystem 804 can provide various functionalities described above. In instances where computer system 800 is executing one or more virtual machines, one or more processing units may be allocated to each virtual machine.

In certain aspects, a processing acceleration unit 806 may optionally be provided for performing customized processing or for off-loading some of the processing performed by processing subsystem 804 so as to accelerate the overall processing performed by computer system 800.

I/O subsystem 808 may include devices and mechanisms for inputting information to computer system 800 and/or for outputting information from or via computer system 800. In general, use of the term input device is intended to include all possible types of devices and mechanisms for inputting information to computer system 800. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 800 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 818 provides a repository or data store for storing information and data that is used by computer system 800. Storage subsystem 818 provides a tangible non-transitory computer-readable storage medium for storing the basic programming and data constructs that provide the functionality of some aspects. Storage subsystem 818 may store software (e.g., programs, code modules, instructions) that when executed by processing subsystem 804 provides the functionality described above. The software may be executed by one or more processing units of processing subsystem 804. Storage subsystem 818 may also provide a repository for storing data used in accordance with the teachings of this disclosure.

Storage subsystem 818 may include one or more non-transitory memory devices, including volatile and non-volatile memory devices. As shown in FIG. 8, storage subsystem 818 includes a system memory 810 and a computer-readable storage media 822. System memory 810 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 800, such as during start-up, may typically be stored in the ROM. The RAM typically contains data and/or program modules that are presently being operated and executed by processing subsystem 804. In some implementations, system memory 810 may include multiple different types of memory, such as static random access memory (SRAM), dynamic random access memory (DRAM), and the like.

By way of example, and not limitation, as depicted in FIG. 8, system memory 810 may load application programs 812 that are being executed, which may include various applications such as Web browsers, mid-tier applications, relational database management systems (RDBMS), etc., program data 814, and an operating system 816. By way of example, operating system 816 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 822 may store programming and data constructs that provide the functionality of some aspects. Computer-readable media 822 may provide storage of computer-readable instructions, data structures, program modules, and other data for computer system 800. Software (programs, code modules, instructions) that, when executed by processing subsystem 804 provides the functionality described above, may be stored in storage subsystem 818. By way of example, computer-readable storage media 822 may include non-volatile memory such as a hard disk drive, a magnetic disk drive, an optical disk drive such as a CD ROM, digital video disc (DVD), a Blu-Ray® disk, or other optical media. Computer-readable storage media 822 may include, but is not limited to, Zip® drives, flash memory cards, universal serial bus (USB) flash drives, secure digital (SD) cards, DVD disks, digital video tape, and the like. Computer-readable storage media 822 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 818 may also include a computer-readable storage media reader 820 that can further be connected to computer-readable storage media 822. Reader 820 may receive and be configured to read data from a memory device such as a disk, a flash drive, etc.

In certain aspects, computer system 800 may support virtualization technologies, including but not limited to virtualization of processing and memory resources. For example, computer system 800 may provide support for executing one or more virtual machines. In certain aspects, computer system 800 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 800. Accordingly, multiple operating systems may potentially be run concurrently by computer system 800.

Communications subsystem 824 provides an interface to other computer systems and networks. Communications subsystem 824 serves as an interface for receiving data from and transmitting data to other systems from computer system 800. For example, communications subsystem 824 may enable computer system 800 to establish a communication channel to one or more client devices via the Internet for receiving and sending information from and to the client devices. For example, the communications subsystem may be used to transmit a response to a user regarding the inquiry for a chatbot.

Communications subsystem 824 may support both wired and/or wireless communication protocols. For example, in certain aspects, communications subsystem 824 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 824 can provide wired network connectivity (e.g., Ethernet) in addition to or instead of a wireless interface.

Communications subsystem 824 can receive and transmit data in various forms. For example, in some aspects, in addition to other forms, communications subsystem 824 may receive input communications in the form of structured and/or unstructured data feeds 826, event streams 828, event updates 830, and the like. For example, communications subsystem 824 may be configured to receive (or send) data feeds 826 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 824 may be configured to receive data in the form of continuous data streams, which may include event streams 828 of real-time events and/or event updates 830, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 824 may also be configured to communicate data from computer system 800 to other computer systems or networks. The data may be communicated in various different forms such as structured and/or unstructured data feeds 826, event streams 828, event updates 830, and the like to one or more databases that may be in communication with one or more streaming data source computers coupled to computer system 800.

Computer system 800 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 800 depicted in FIG. 8 is intended only as a specific example. Many other configurations having more or fewer components than the system depicted in FIG. 8 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

1. A non-transitory computer-readable medium including instructions that when executed by one or more processors, cause the one or more processors to perform operations including:
receiving a plurality of reports corresponding to a plurality of report identifiers;
identifying, using a language model, a first subset of the plurality of report identifiers as satisfying a first suspiciousness criterion;
determining (i) a total number of report identifiers within the first subset of the plurality of report identifiers and (ii) a total number of report identifiers within the plurality of report identifiers;
determining a factor that is based at least in part on (i) the total number of report identifiers within the first subset of the plurality of report identifiers and (ii) the total number of report identifiers within the plurality of report identifiers;
setting a parameter of an anomaly detection algorithm, based at least in part on the factor, the anomaly detection algorithm being different from the language model;
identifying, using the anomaly detection algorithm having the parameter set based at least in part on the factor, a second subset of the plurality of report identifiers as satisfying a second suspiciousness criterion; and
flagging, for at least one report identifier within the second subset of the report identifiers, the report corresponding to the at least one report identifier as being potentially anomalous.

2. The non-transitory computer-readable medium of claim 1, wherein flagging the report comprises:
identifying that the at least one report identifier is within the first subset of the report identifiers and within the second subset of the report identifiers; and
in response to identifying that the at least one report identifier is within the first subset of the report identifiers and within the second subset of the report identifiers, flagging, for the at least one report identifier, the report corresponding to the at least one report identifier as being potentially anomalous.

3. A non-transitory computer-readable medium including instructions that when executed by one or more processors, cause the one or more processors to perform operations including:
receiving a plurality of reports corresponding to a plurality of report identifiers;
identifying, using a language model, a first subset of the plurality of report identifiers as satisfying a first suspiciousness criterion;
determining a factor that is based at least in part on the first subset of the plurality of report identifiers;
setting a parameter of an anomaly detection algorithm, based at least in part on the factor, the anomaly detection algorithm being different from the language model;
identifying, using the anomaly detection algorithm, a second subset of the plurality of report identifiers as satisfying a second suspiciousness criterion; and
identifying (i) a first report corresponding to a first report identifier that is within the first subset of the report identifiers and the second subset of the report identifiers, and (ii) a second report corresponding to a second report identifier that is within the second subset of the report identifiers and not within the first subset of the report identifiers; and
flagging (i) the first report as being potentially anomalous with a first confidence level, and (ii) the second report as being potentially anomalous with a second confidence level,
wherein the first confidence level is higher than the second confidence level.

4. The non-transitory computer-readable medium of claim 3, wherein the operations further include:
flagging, for a third report identifier that is within the first subset of the report identifiers and not within the second subset of the report identifiers, a third report corresponding to the third report identifier as being potentially anomalous with a third confidence level,
wherein the first confidence level is higher than the third confidence level.

5. The non-transitory computer-readable medium of claim 4, wherein the second confidence level and the third confidence level are the same.

6. The non-transitory computer-readable medium of claim 1, wherein the operations further include:
subsequent to identifying the second subset of the plurality of report identifiers, determining a ratio of (i) a number of unique report identifiers that are within both the first subset and the second subset, and (ii) a number of unique report identifiers that are within at least one of the first subset and the second subset;
determining that the ratio is less than a threshold;
in response to determining that the ratio is less than the threshold, tuning one or more parameters of the anomaly detection algorithm; and
updating, using the anomaly detection algorithm with the tuned one or more parameters, the second subset of the plurality of report identifiers as satisfying the second suspiciousness criterion,
wherein the at least one report identifier is within the second subset of the report identifiers subsequent to the updating of the second subset.

7. The non-transitory computer-readable medium of claim 6, wherein the threshold is at least 0.5.

8. The non-transitory computer-readable medium of claim 6, wherein the anomaly detection algorithm is an isolation forest, and wherein the one or more parameters that are tuned comprise one or more of:
a contamination parameter that specifies a proportion of a dataset is expected to be identified by the isolation forest as being anomalous;
a number of individual isolation trees within the isolation forest;
a subsampling size that specifies a number of samples to draw from a training data for each isolation tree;
a number of features to consider for splitting at each node in the isolation trees; and
an outlier score threshold that defines a threshold above which data points are flagged as outliers.

9. The non-transitory computer-readable medium of claim 1, wherein the anomaly detection algorithm is an isolation forest, and wherein setting the parameter of the anomaly detection algorithm comprises:
setting a contamination parameter of the isolation forest as a function of the factor.

10. The non-transitory computer-readable medium of claim 1, wherein the anomaly detection algorithm is an isolation forest, and wherein setting the parameter of the anomaly detection algorithm comprises:
setting a contamination parameter of the isolation forest to be equal to the factor.

11. The non-transitory computer-readable medium of claim 1, wherein the factor is based at least in part on a ratio of (i) the total number of report identifiers within the first subset of the plurality of report identifiers and (ii) the total number of report identifiers within the plurality of report identifiers.

12. The non-transitory computer-readable medium of claim 1, wherein the operations further include:
prior to identifying the first subset and the second subset, processing the plurality of reports, wherein processing the plurality of reports comprises translating a description of an report from a first language to a second language.

13. The non-transitory computer-readable medium of claim 1, wherein the operations further include:
prior to identifying the first subset and the second subset, processing the plurality of reports, wherein processing the plurality of reports comprises determining, using a small language model and from a description of a report, a number of personnel and/or a number of days associated with an event for the report.

14. The non-transitory computer-readable medium of claim 1, wherein the operations further include:
prior to identifying the first subset and the second subset, processing the plurality of reports, wherein processing the plurality of reports comprises determining, from a description of a report, a type of an event for the report.

15. The non-transitory computer-readable medium of claim 1, wherein the language model is a pretrained small language model (SLM).

16. The non-transitory computer-readable medium of claim 1, wherein the anomaly detection algorithm is an isolation forest.

17. A method comprising:
receiving a plurality of reports corresponding to a plurality of report identifiers;
identifying, using a language model, a first subset of the plurality of report identifiers as satisfying a first suspiciousness criterion;
determining (i) a total number of report identifiers within the first subset of the plurality of report identifiers and (ii) a total number of report identifiers within the plurality of report identifiers;
determining a factor that is based at least in part on (i) the total number of report identifiers within the first subset of the plurality of report identifiers and (ii) the total number of report identifiers within the plurality of report identifiers;
setting a parameter of an anomaly detection algorithm, based at least in part on the factor, the anomaly detection algorithm being different from the language model;
identifying, using the anomaly detection algorithm having the parameter set based at least in part on the factor, a second subset of the plurality of report identifiers as satisfying a second suspiciousness criterion; and
flagging, for at least one report identifier within the second subset of the report identifiers, the report corresponding to the at least one report identifier as being potentially anomalous.

18. The method of claim 17, wherein:
the factor is based at least in part on a ratio of (i) a number of report identifiers within the first subset of the plurality of report identifiers and (ii) a number of report identifiers within the plurality of report identifiers;
the anomaly detection algorithm is an isolation forest; and
the parameter is a contamination parameter of the isolation forest.

19. A system comprising:
one or more processors; and
one or more non-transitory computer-readable media storing instructions, which, when executed by the system, cause the system to perform a set of actions including:
receiving a plurality of reports corresponding to a plurality of report identifiers;
identifying, using a language model, a first subset of the plurality of report identifiers as satisfying a first suspiciousness criterion;
determining (i) a total number of report identifiers within the first subset of the plurality of report identifiers and (ii) a total number of report identifiers within the plurality of report identifiers;
determining a factor that is based at least in part on (i) the total number of report identifiers within the first subset of the plurality of report identifiers and (ii) the total number of report identifiers within the plurality of report identifiers;
setting a parameter of an anomaly detection algorithm, based at least in part on the factor, the anomaly detection algorithm being different from the language model;
identifying, using the anomaly detection algorithm having the parameter set based at least in part on the factor, a second subset of the plurality of report identifiers as satisfying a second suspiciousness criterion; and
flagging, for at least one report identifier within the second subset of the report identifiers, the report corresponding to the at least one report identifier as being potentially anomalous.

20. The system of claim 19, wherein:
the factor is based at least in part on a ratio of (i) a number of report identifiers within the first subset of the plurality of report identifiers and (ii) a number of report identifiers within the plurality of report identifiers;
the anomaly detection algorithm is an isolation forest; and
the parameter is a contamination parameter of the isolation forest.
